(19) United States
(12) Patent Application Publication
(10) Pub. No.: US 2017/0185942 A1
(43) Pub. Date: Jun. 29, 2017

(54) GENERATION OF OPTIMAL TEAM CONFIGURATION RECOMMENDATIONS

(71) Applicant: INTERNATIONAL BUSINESS MACHINES CORPORATION, ARMONK, NY (US)

(72) Inventors: Roslyn Hickson, North Fitzroy (AU); Timothy M. Lynar, Melbourne (AU); John M. Wagner, Plainville, CT (US); Daniel K. Weber, Ascot Vale (AU)

(21) Appl. No.: 14/980,629

(22) Filed: Dec. 28, 2015

(51) Int. Cl. G06Q 10/06

(52) U.S. Cl. CPC G06Q 10/063112; G06Q 10/063118

(57) ABSTRACT

Embodiments include method, systems and computer program products to generate optimal team configuration recommendations. In some embodiments, parameters and project data associated with a project may be received. Employee data may be received from one or more sources. The employee data, the project data, and the parameters associated with the project may be analyzed. A team-member compatibility matrix may be generated using cognitive analysis based on the analyzed employee data, the project data, and the parameters associated with the project. Optimal and para-optimal team configurations may be calculated using the team-member compatibility matrix. A team configuration recommendation may be generated using the optimal and para-optimal team configurations. The team configuration recommendation may be transmitted.

### BACKGROUND

The present disclosure relates to data analysis, and more specifically, to methods, systems and computer program products for generation of optimal team configuration recommendations.

Companies often employ many different with diverse skill sets and experience. Many companies require that employees work in collaborative groups to complete projects. The effective assignment of individuals to collaborative projects is often limited to the subjective assessment of project requirements by managing parties. Such subjective assessments may not take into account the different types of skills sets or experience available in the company. In many cases, managers may simply assign people who are physically close to them or with whom they have some experience. Such subjective assessments and random assignments may generate groups that are less effective and efficient than if additional factors had been considered.

### SUMMARY

In accordance with an embodiment, a method for generation of optimal team configuration recommendations is provided. The method may include receiving parameters and project data associated with a project; obtaining employee data from one or more sources; analyzing the employee data, the project data, and the parameters associated with the project generating a team-member compatibility matrix using cognitive analysis based on the analyzed employee data, the project data, and the parameters associated with the project; calculating optimal and para-optimal team configurations using the team-member compatibility matrix; generating a team configuration recommendation using the optimal and para-optimal team configurations; and transmitting the team configuration recommendation.

In another embodiment, a computer program product may comprise a non-transitory storage medium readable by a processing circuit and storing instructions for execution by the processing circuit for performing a method that may include receiving parameters and project data associated with a project; obtaining employee data from one or more sources; analyzing the employee data, the project data, and the parameters associated with the project; generating a team-member compatibility matrix using cognitive analysis based on the analyzed employee data, the project data, and the parameters associated with the project; calculating optimal and para-optimal team configurations using the team-member compatibility matrix; generating a team configuration recommendation using the optimal and para-optimal team configurations; and transmitting the team configuration recommendation.

In another embodiment, a system for optimizing persistency using hybrid memory may include a processor in communication with one or more types of memory. The processor may be configured to receive parameters and project data associated with a project; obtain employee data from one or more sources; analyze the employee data, the project data, and the parameters associated with the project; generate a team-member compatibility matrix using cognitive analysis based on the analyzed employee data, the project data, and the parameters associated with the project; calculate optimal and para-optimal team configurations using the team-member compatibility matrix; generate a team configuration recommendation using the optimal and para-optimal team configurations; and transmit the team configuration recommendation.

### BRIEF DESCRIPTION OF THE DRAWINGS

The forgoing and other features, and advantages of the disclosure are apparent from the following detailed description taken in conjunction with the accompanying drawings in which:

FIG. 1 is a block diagram illustrating one example of a processing system for practice of the teachings herein;

FIG. 2 is a block diagram illustrating a computing system in accordance with an exemplary embodiment; and

FIG. 3 is a flow diagram of a method for generating optimal team configuration recommendations in accordance with an exemplary embodiment.

### DETAILED DESCRIPTION

In accordance with exemplary embodiments of the disclosure, methods, systems and computer program products for generation of optimal team configuration recommendations are provided. The methods and systems described herein are directed to a system that methodically obtains information about a project and evaluates the employees using objective analyses. Characteristics of potential team members (i.e., skill sets, personality traits availability, etc.) and the requirements for a designated collaborative project are objectively determined by the systems and methods described herein. With both the pool of potential team members and the nature of the project objectively defined, one or more optimal team configuration recommendations may be made based on a training dataset of past projects and the teams assigned as well as characteristics of the employees and requirements of the project.

Data associated with employees may be collected from different sources. For example, data may be obtained through social media, any available communications data of the employee (including email, calendar, to-do lists, etc.), the skills, availability, workloads, personality traits, productivity etc. of each individual. Project data may be obtained through statements of work, project plans, project descriptions, requirements, project communications, etc. the project requirements, time requirements, and lists of roles and their potential skills, team characteristics, etc. Employee data and project data and requirements may then be analyzed and used to generate optimal team configuration recommendation. The method of analysis may be cognitive analysis, which may include a cognitive model of a user, which may describe the way a user filters and processes stimulation from their environment. In some embodiments, the cognitive analysis may include a contextual model of a user, which describes how a user is predicted to act within a given context; in this case a set of proposed interactions.

In one example embodiment, the skill sets needed for each team position may be determined. The closeness of contact between each team position (e.g. strength of interactions) for a new project may be predicted from a training set of past employee data (e.g., number of emails between individuals, etc.), or estimated in the project management module by a user. The system may maximize the cumulative weighted compatibility of team members with one another based on the aforementioned information to generate optimal team configuration recommendations.

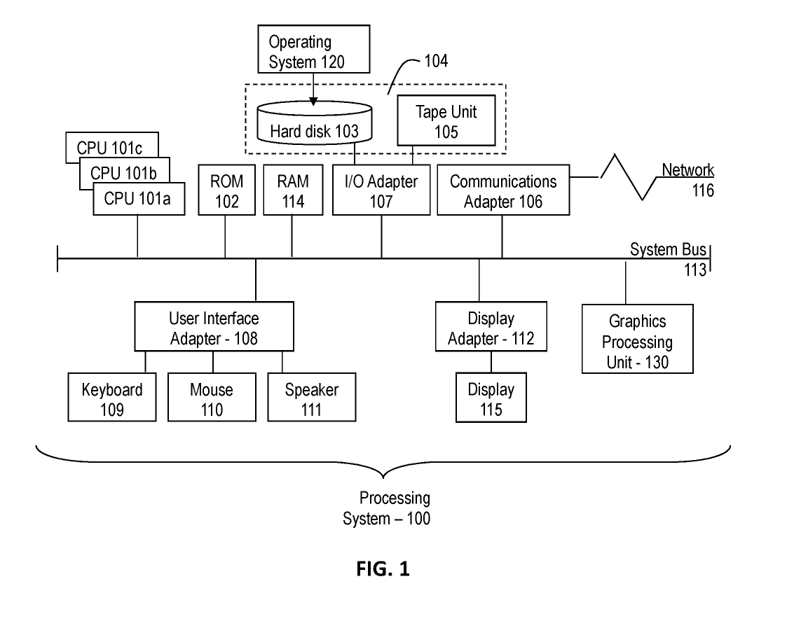

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics-processing unit 130. Graphics processing unit 130 is a specialized electronic circuit designed to manipulate and alter memory to accelerate the creation of images in a frame buffer intended for output to a display. In general, graphics-processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

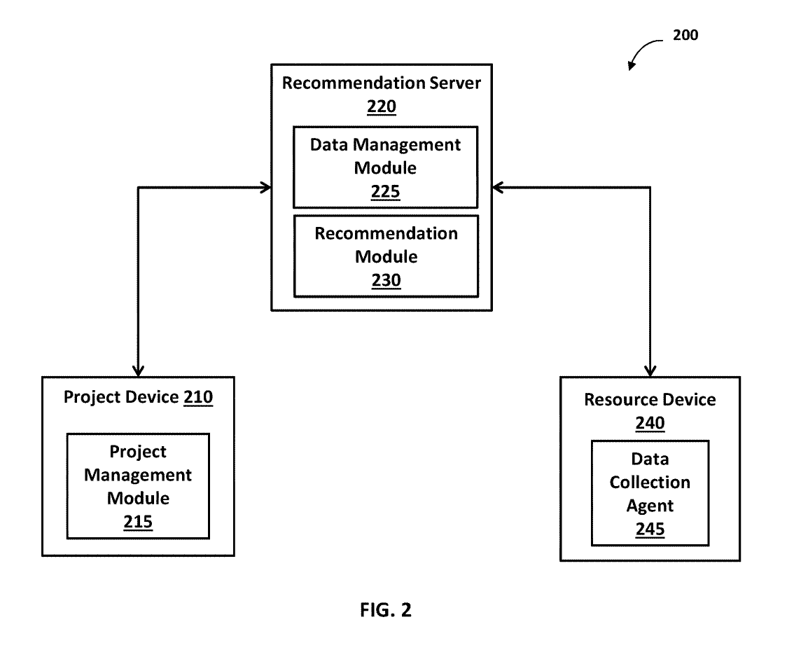

Referring now to FIG. 2, a computing system 200 in accordance with an embodiment is illustrated. As illustrated, the computing system 200 may include, but is not limited to, a project device 210, a recommendation server 220, and one or more resource device(s) 240. A project device 210 may include a project management module 215. A recommendation server 220 may include a data management module 225 and/or a recommendation module 230. A resource device 240 may include a data collection agent 245.

In some embodiments, the project device 210 may maybe any type of user device, which may include smartphones, tablets, laptops, desktop, server, and the like. A project device 210 may include a project management module 215. The project management module 215 may include computer-readable instructions that in response to execution by the processor(s) 101 cause operations to be performed including receiving information from a user, such as details associated with a project. Examples of such information may include statements of work, project analyses, projection descriptions, requirements analyses, projection communications, and/or desired work product. In some embodiments, the project management module 215 may display a user interface to a user, through which a user may provide project data and/or project parameters. Project data may be descriptive data associated with the project. Project parameters may be project requirements (e.g., number of employees required, timelines, budgets, etc.). In some embodiments, the project management module 215 may be a web-based interface accessibly by the project device 210. In some embodiments, the project management module 215 may be a local client executing on the project device 210.

In some embodiments, the recommendation server 220 may maybe any type of computing device, which may include desktop, server, and the like. In some embodiments, the recommendation server 220 may include a data management module 225 and a recommendation module 230. The data management module 225 may include computer-readable instructions that in response to execution by the processor(s) 101 cause operations to be performed including receiving project data and parameters from the project device 210 and obtaining employee data from one or more sources, such as a resource device 240 and/or data store. The data management module 225 may generate a structured employee profile for each potential individual that may be selected for the team configuration recommendation. Each structured profile may be generated using the employee data obtained from one or more sources. The employee data obtained from the different sources may be unstructured, semi-structured, or structured data. In some embodiments, the data management module 225 may generate a structured project profile using the project data received from the project device 210.

The recommendation module 230 may include computer-readable instructions that in response to execution by the processor(s) 101 cause operations to be performed including generating one or more optimal team configurations based on the data from the data management module 225. For example, the recommendation module 230 may analyze the employee data and the project data (e.g., structured employee profile and structured project profile). In some embodiments, the recommendation module 230 may analyze the employee data and the project data and generate one or more optimal team configurations using machine learning techniques. In some embodiments, the recommendation module 230 may generate multiple configuration recommendations and may rank them. The recommendation module 230 may transmit the team configuration recommendations to the data management module 225, which may then transmit the configurations to the project device 210.

In some embodiments, resource device 240 may be any type of user device, which may include smartphones, tablets, laptops, desktop, server, and the like. A resource device 240 may include a data collection agent 245. The data collection agent 245 may include computer-readable instructions that in response to execution by the processor(s) 101 cause operations to be performed including obtaining data associated with an identified individual. Examples of the types of information that may be obtained include, but are not limited to emails, social media communication logs, education, salaries, employment positions, experience on prior project, or prior training. The data may be unstructured, semi-structured, or structured. In some embodiments, the resource device 240 may be a device utilized by an employee who is a potential candidate for the team. The data resource device 240 may be a device that provides sensitive information (e.g., salary, personnel file, etc.), a resume, sensor data, or other information, and may be a device maintained by the human resources department of the group. Such information may be provided to the recommendation server 220 for use in the analysis but may not be revealed to anyone else in the company without proper credentials. In some embodiments, the data may be implicit data obtained through monitoring or scanning systems of the company or explicit information, such as preferences provided by the employee or evaluations provided by a supervisor or manager.

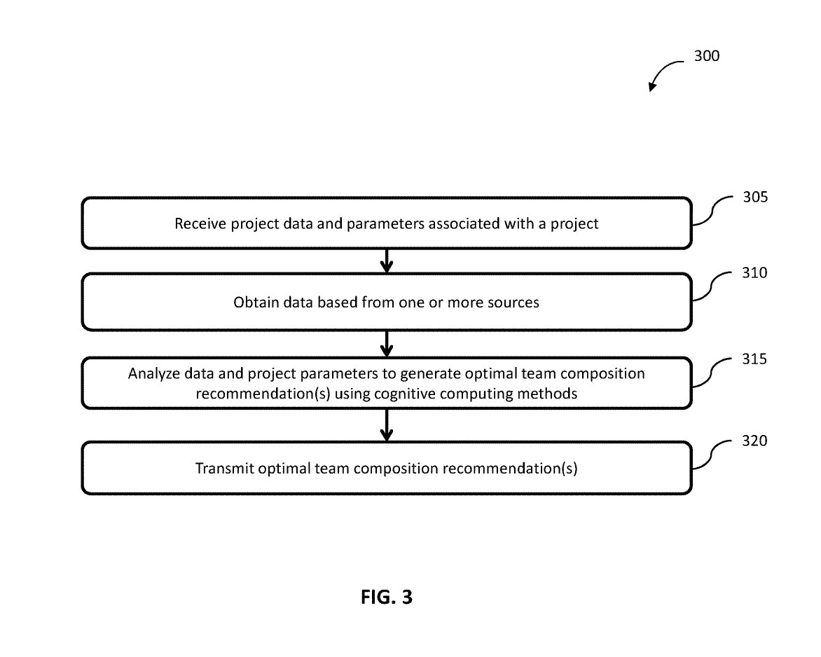

Now referring to FIG. 3, is a flow diagram of a method 300 for generating optimal team configuration recommendations in accordance with an exemplary embodiment is shown. At block 305, a recommendation server 220 may receive project data and parameters associated with a project. In some embodiments, the project data and parameters associated with the project may be obtained by the project management module 215 of the project device 210. The data may be obtained from a user, such as a project manager, through an interface presented to the user. In some embodiments, the project management module 215 may receive the data and may transmit the data to the data management module 225 of the recommendation server 220 over a network connection. Project data may be descriptive data associated with the project, which may include but is not limited to, statements of work, project descriptions, project communications, project plans, and the like. Project parameters may be project requirements (e.g., number of employees required, timelines, budgets, desired work product, requirements analyses, etc.).

At block 310, the recommendation server 220 may obtain data from one or more sources. In some embodiments, the data management module 225 may obtain data from one or more resource devices 240. The data may be employee data. The data may be structured, semi-structured, or unstructured. In some embodiments, the data may be collected by a data collection agent 245 executing on the resource device 240. Examples of data that may be collected from a resource device 240 may include, but is not limited to, emails, social media communication logs, education, salaries, employment positions, experience on prior project, or prior training. In some embodiments, the collected data may be sensitive information (e.g., salary, personnel file, etc.), a resume, or other information. Such information may be provided to the data management module 225 for use in the analysis but may not be revealed to anyone without the proper credentials. In some embodiments, the data may be implicit data obtained through monitoring or scanning systems of the company or explicit information, such as preferences provided by the employee or evaluations provided by a supervisor or manager

At block 315, the recommendation server 220 may analyze data and project parameters to generate one or more optimal team configuration recommendations. In some embodiments, the data and project parameters may be analyzed using cognitive analysis. In some embodiments, cognitive analysis may include a cognitive model of a user, which may describe the way a user filters and processes stimulation from their environment. In some embodiments, the cognitive analysis may include a contextual model of a user, which describes how a user is predicted to act within a given context; in this case a set of proposed interactions.

In one example embodiment, the skill sets needed for each team position may be determined. The closeness of contact between each team position (e.g. strength of interactions) for a new project may be predicted from a training set of past employee data (e.g., number of emails between individuals, etc.), or estimated in the project management module by a user. The system may maximize the cumulative weighted compatibility of team members with one another based on the aforementioned information to generate optimal team configuration recommendations.

The recommendation module 230 may analyze the employee data, the project data, and the parameters associated with the project. In some embodiments, the recommendation module may generate a team-member compatibility matrix using cognitive analysis based on the analyzed employee data, the project data, and the parameters associated with the project. Optimal and para-optimal team configurations may be calculated using the team-member compatibility matrix. The recommendation module 230 may generate a team configuration recommendation using the optimal and para-optimal team configurations.

In some embodiments, the recommendation module 230 may generate weighted factors using the parameters associated with the project and analyze the employee data using the weighted factors. In some embodiments, the recommendation module 230 may generate a structured employee profile for each potential individual that may be selected for the team configuration recommendation. Each structured profile is generated using the employee data. The recommendation module 230 may generate a structured project profile using the project data. The recommendation module 230 may analyze each structured employee profile and structured project profile and generate one or more the team configuration recommendations based on each analyzed structured employee profile, the analyzed structure project profile, and the parameters associated with the project.

In some embodiments, an optimal team configuration assignment is then made from an available pool of individuals based on a match between employee profiles and the project profile. In some embodiments, the optimal team configuration assignment may be based on analysis of employee and project profiles with respect to a machine learning mechanisms using provided training datasets. In some embodiments, the cumulative weighted compatibility of team members with one another may be maximized and weighted by closeness of position in the company as well as experience.

In some embodiments, the optimal team configurations may be in any form interpretable by the user (e.g., graph, plot, spreadsheet etc.). In some embodiments, multiple team configuration recommendations may be generated. In some embodiments, the recommendations may be ranked, for example, based on the project parameters. If the team configuration recommendation lacks a critical characteristic, the recommendation module 230 may suggest one or more employees outside of the analyzed pool with identified characteristics or skills.

At block 320, the recommendation server 220 may transmit the optimal team configuration recommendation(s). In some embodiments, the data management module 225 may transmit the one or more optimal team configuration recommendations (and their corresponding rankings, if relevant) to the project device 210. In some embodiments, the data management module 225 may add the team configuration recommendations to a training dataset. The training dataset is used to train the machine learning algorithms used to generate future team configuration recommendations. The training dataset may include the profile of past projects and the employee profiles of the team assigned to that project, and a measure of success (i.e., a score) determined for that project.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method comprising:
receiving parameters and project data associated with a project;
obtaining employee data from one or more sources;
analyzing the employee data, the project data, and the parameters associated with the project;
generating a team-member compatibility matrix using cognitive analysis based on the analyzed employee data, the project data, and the parameters associated with the project, wherein the cognitive analysis comprises a contextual model of a team-member and a cognitive model of the team-member, wherein the contextual model describes how the team-member is predicted to act within a given context, and wherein the cognitive model describes the way in which the team-member filters and processes stimulation from an environment of the team-member;
calculating optimal and para-optimal team configurations using the team-member compatibility matrix;
generating a team configuration recommendation using the optimal and para-optimal team configurations; and
transmitting the team configuration recommendation.

2. The computer-implemented method of claim 1, wherein the employee data comprises one or more of: emails, social media communication logs, education, salaries, employment positions, experience on prior project, or prior training.

3. The computer-implemented method of claim 1, wherein the project data comprises one or more of: statements of work, project plans, project descriptions, requirements analyses, project communications, or desired work product.

4. The computer-implemented method of claim 1, wherein analyzing the employee data, the project data, and the parameters associated with the project further comprises:
generating weighted factors using the parameters associated with the project; and
analyzing the employee data using the weighted factors.

5. The computer-implemented method of claim 1, further comprising:
adding the team configuration recommendation to a training dataset, wherein the training dataset is used to train machine learning algorithms used to generate future team configuration recommendations.

6. The computer-implemented method of claim 1, wherein the team configuration recommendation is a first team configuration recommendation and the method further comprises:
updating the team-member compatibility matrix;
generating a second team configuration recommendation based on analyzed employee data, the project data, the parameters associated with the project, and the updated team-member compatibility matrix;
ranking the first team configuration recommendation and the second team configuration recommendation based on the parameters associated with the project; and
transmitting the ranking of the first team configuration recommendation and the second team configuration recommendation.

7. The computer-implemented method of claim 1, wherein generating the team configuration recommendation further comprises:
generating a structured employee profile for each potential individual that may be selected for the team configuration recommendation, wherein each structured profile is generated using the employee data;
generating a structured project profile using the project data;
analyzing each structured employee profile and structured project profile; and
generating the team configuration recommendation based on each analyzed structured employee profile, the analyzed structure project profile, the parameters associated with the project, and the team-member compatibility matrix.

8. A computer program product comprising a non-transitory storage medium readable by a processing circuit and storing instructions for execution by the processing circuit for performing a method comprising:
receiving parameters and project data associated with a project;
obtaining employee data from one or more sources;
analyzing the employee data, the project data, and the parameters associated with the project;
generating a team-member compatibility matrix using cognitive analysis based on the analyzed employee data, the project data, and the parameters associated with the project, wherein the cognitive analysis comprises a contextual model of a team-member and a cognitive model of the team-member, wherein the contextual model describes how the team-member is predicted to act within a given context, and wherein the cognitive model describes the way in which the team-member filters and processes stimulation from an environment of the team-member;
calculating optimal and para-optimal team configurations using the team-member compatibility matrix;
generating a team configuration recommendation using the optimal and para-optimal team configurations; and
transmitting the team configuration recommendation.

9. The computer program product of claim 8, wherein the employee data comprises one or more of: emails, social media communication logs, education, salaries, employment positions, experience on prior project, or prior training.

10. The computer program product of claim 8, wherein the project data comprises one or more of: statements of work, project plans, project descriptions, requirements analyses, or project communications, desired work product.

11. The computer program product of claim 8, wherein analyzing the employee data, the project data, and the parameters associated with the project further comprises:
generating weighted factors using the parameters associated with the project; and
analyzing the employee data using the weighted factors.

12. The computer program product of claim 8, the method further comprising:
adding the team configuration recommendation to a training dataset, wherein the training dataset is used to train machine learning algorithms used to generate future team configuration recommendations.

13. The computer program product of claim 8, wherein the team configuration recommendation is a first team configuration recommendation and the method further comprises:
updating the team-member compatibility matrix;
generating a second team configuration recommendation based on analyzed employee data, the project data, the parameters associated with the project, and the updated team-member compatibility matrix;
ranking the first team configuration recommendation and the second team configuration recommendation based on the parameters associated with the project; and
transmitting the ranking of the first team configuration recommendation and the second team configuration recommendation.

14. The computer program product of claim 8, wherein generating the team configuration recommendation further comprises:
generating a structured employee profile for each potential individual that may be selected for the team configuration recommendation, wherein each structured profile is generated using the employee data;
generating a structured project profile using the project data;
analyzing each structured employee profile and structured project profile; and
generating the team configuration recommendation based on each analyzed structured employee profile, the analyzed structure project profile, the parameters associated with the project, and the team-member compatibility matrix.

15. A system, comprising:
a processor in communication with one or more types of memory, the processor configured to:
receive parameters and project data associated with a project;
obtain employee data from one or more sources;
analyze the employee data, the project data, and the parameters associated with the project;
generate a team-member compatibility matrix using cognitive analysis based on the analyzed employee data, the project data, and the parameters associated with the project, wherein the cognitive analysis comprises a contextual model of a team-member and a cognitive model of the team-member, wherein the contextual model describes how the team-member is predicted to act within a given context, and wherein the cognitive model describes the way in which the team-member filters and process stimulation from an environment of the team-member;
calculate optimal and para-optimal team configurations using the team-member compatibility matrix;
generate a team configuration recommendation using the optimal and para-optimal team configurations; and
transmit the team configuration recommendation.

16. The system of claim 15, wherein the employee data comprises one or more of: emails, social media communication logs, education, salaries, employment positions, experience on prior project, or prior training.

17. The system of claim 15, wherein the project data comprises one or more of: statements of work, project plans, project descriptions, requirements analyses, or project communications, desired work product.

18. The system of claim 15, wherein, to analyze the employee data, the project data, and the parameters associated with the project, the processor is further configured to:
generate weighted factors using the parameters associated with the project; and
analyze the employee data using the weighted factors.

19. The system of claim 15, wherein the team configuration recommendation is a first team configuration recommendation and wherein the processor is further configured to:
updating the team-member compatibility matrix;
generating a second team configuration recommendation based on analyzed employee data, the project data, the parameters associated with the project, and the updated team-member compatibility matrix;
rank the first team configuration recommendation and the second team configuration recommendation based on the parameters associated with the project; and
transmit the ranking of the first team configuration recommendation and the second team configuration recommendation.

20. The system of claim 15, wherein to generate the team configuration recommendation, the processor is further configured to:
generate a structured employee profile for each potential individual that may be selected for the team configuration recommendation, wherein each structured profile is generated using the employee data;
generate a structured project profile using the project data;
analyze each structured employee profile and structured project profile; and
generate the team configuration recommendation based on each analyzed structured employee profile, the analyzed structure project profile, the parameters associated with the project, and the team-member compatibility matrix.
